(19) United States
(12) Patent Application Publication
(10) Pub. No.: US 2017/0211543 A1
(43) Pub. Date: Jul. 27, 2017

(54) COMPOSITE COMPONENT HAVING A SAFETY EDGE

(71) Applicant: Vestas Wind Systems A/S, Aarhus N. (DK)

(72) Inventors: Stephen Sandercock, Ryde, Isle Of Wight (GB); Steve Wardropper, New Milton, Hampshire (GB)

(21) Appl. No.: 15/500,340

(22) PCT Filed: Jul. 29, 2015
(86) PCT No.: PCT/DK2015/050229

§ 371 Date: Jan. 30, 2017

(30) Foreign Application Priority Data
Jul. 31, 2014 (GB) 1413551.1

(51) Int. Cl. F03D 1/06; B29D 99/00; B29C 70/78; B32B 7/12; B32B 5/24; B32B 3/08; B32B 5/18; B29C 70/02; B32B 5/02

(52) U.S. Cl. CPC F03D 1/0683; B29C 70/028; B29D 99/0025; B29C 70/78; B32B 5/02; B32B 5/245; B32B 3/08; B32B 5/18; B32B 7/12; B29L 2031/085

(57) ABSTRACT

A composite component (130) such as a shear web for a wind turbine blade is described. The component comprises a moulded laminate (44) formed from one or more fibrous layers (40) integrated by resin and defining a laminate edge (48). An edging strip (60) is located adjacent to the laminate edge (48) and is integrated with the laminate. In a particular example, the edging (60) is made from closed-cell foam. Accordingly, resin does not permeate into the bulk of the edging (60) during the moulding process. After the moulding process, a portion (60a) of the edging (60) is removed to reveal an exposed, substantially resin-free surface of the edging which defines a safety edge (64) of the component.

### FIELD OF THE INVENTION

The invention relates to composite components having a safety edge to facilitate handling, and to methods of manufacturing such components. The invention has particular application to composite components used in the manufacture of wind turbine blades.

### BACKGROUND TO THE INVENTION

FIG. 1 illustrates in perspective view a prior art wind turbine blade 10. The wind turbine blade 10 extends longitudinally from a generally cylindrical root 11 to a tip 13. In use, the root end 11 of the blade 10 is attached to a hub of a wind turbine (not shown). In cross-section, the blade 10 transitions from a circular profile at the root 11 to an airfoil profile at the widest part of the blade 10, which is known as the ‘shoulder’ 15. Between the shoulder 15 and the tip 13, the blade has an airfoil profile that steadily decreases in thickness and chord moving towards the tip 13.

FIG. 2 illustrates the blade 10 in cross-section and reveals that the blade 10 comprises an outer shell 12, which is fabricated from two half shells: a leeward shell 14 and a windward shell 16. The shells 14, 16 are moulded from glass-fibre reinforced plastic (GRP). Parts of the outer shell 12 are of sandwich panel construction and comprise a core 18 of lightweight foam (e.g. polyurethane), which is sandwiched between inner and outer GRP layers 20, 22 or ‘skins’.

The blade 10 comprises first and second pairs of spar caps 24, 26, 28, 30 arranged between sandwich panel regions of the outer shell 12. One spar cap of each pair 24, 28 is integrated with the windward shell 16 and the other spar cap of each pair 26, 30 is integrated with the leeward shell 14. The spar caps 24, 26, 28, 30 of the respective pairs are mutually opposed and extend longitudinally along the length of the blade 10. A first longitudinally-extending shear web 32 bridges the first pair of spar caps 24, 26 and a second longitudinally-extending shear web 34 bridges the second pair of spar caps 28, 30. The shear webs 32, 34 in combination with the spar caps 24, 26, 28, 30 form a pair of I-beam structures, which transfer loads effectively from the rotating blade 10 to the hub of the wind turbine (not shown). The spar caps 24, 26, 28, 30 in particular transfer tensile and compressive bending loads, whilst the shear webs 32, 34 transfer shear stresses in the blade 10.

The shear webs 32, 34 are made in a vacuum-assisted resin transfer moulding process (VARTM). The process is illustrated in FIG. 3, which shows only a bottom part of the web. Layers of glass fibre fabric 40 are laid up on the surface of a mould tool 50. Edges 42 of the layers are aligned to define an edge 43 of the shear web 32, 34. The layers 40 are enclosed by a vacuum bag 46 to define a sealed area around the layers 40. Air is then removed from the bag 46 by a vacuum pump, and resin is introduced into the bag 46. The resin infuses between and into the glass fibre layers 40. The mould tool 50 is then heated to cure the resin, and once the resin is cured, the component is demoulded.

The resulting shear web 32, 34 has an edge 43 that is defined by the aligned edges 42 of the glass fibre layers 40 and the cured resin in the region of those edges 42. It is difficult to align the edges 42 accurately when the layers 40 are laid on the mould tool 50, and so the edge 43 tends to be uneven. Furthermore, uneven amounts of excess resin tend to be present at the edge 43 of the shear web 32, 34 after the resin infusion. The result is that after the resin has been cured, the edge 43 of the shear web 32, 34 tends to be rough, with the hard cured resin at the edge 43 forming serrations. The rough edge 43 may therefore present a safety hazard making the shear web 32, 34 difficult and potentially unsafe to handle.

The potentially hazardous rough edge 43 can be removed post-fabrication by trimming the edge of the component. However, the cured resin is very hard, and a diamond cutting saw is required to cut through the component to trim the edge, making the trimming an expensive and time-consuming process.

The edge 43 can be neatened prior to the curing process by folding over edges of the glass fibre layers 40 when they are laid in the mould tool 50; however this only partially mitigates the problem, and in practice trimming is still required post-fabrication. The edge 43 can also be neatened by providing the mould tool with an abutment piece in the form of a metal bar or strip, and laying the glass fibre layers 40 against the abutment piece. When the component is de-moulded, the resulting edge is neater. However, even in this case the roughness remain to some extent, and the act of de-moulding the component still tends to leave fractured regions of resin that present sharp and hazardous edges.

### SUMMARY OF THE INVENTION

Against this background, the invention resides in a method of making a composite component for a wind turbine blade, the composite component having a safety edge, and the method comprising: arranging one or more fibrous layers in a mould such that the layers define a laminate edge; arranging an edging adjacent to the laminate edge; integrating the fibrous layers and the edging by means of resin; substantially preventing the resin from permeating into the edging; and removing a portion of the edging to reveal a substantially resin-free exposed surface of the edging that defines a safety edge of the component.

The method of the invention provides a simple and efficient means for providing a hand-safe edge on a composite component for a wind turbine blade, without the need for lengthy and expensive processing after the component has been fabricated. The edging is integrated into the component during fabrication, and the substantially resin-free exposed surface of the edging is easily provided by removing a portion of the edging. Because resin has not been allowed to permeate into the edging, the core of the edging is free from hardened resin, and a portion of the edging can therefore be removed quickly and easily, without the need for elaborate tools.

The step of removing a portion of the edging may comprise severing the edging along a severance line spaced apart from the laminate edge, and removing a sacrificial portion of the edging outboard of the severance line such that a shield portion of the edging inboard of the severance line remains integrated with the laminate and includes the substantially resin-free exposed surface defining the safety edge of the component.

Severing the edging at the severance line provides a particularly simple method of removing part of the edging. The severing process can be carried out by hand, for example using a hand-held cutting tool, or the severing process could be mechanised.

The edging may be made from substantially resin impermeable material such that the resin is substantially prevented from permeating into the edging. Using substantially resin impermeable material is particularly advantageous as it means that no additional measures are necessary to prevent resin permeating into the edging.

The method may further comprise arranging a plurality of fibrous layers, one on top of the other, in the mould to form the laminate.

The method may comprise removably fixing the edging to the mould. In this way, the edging can be fixed in place to define a secure border, and the fibrous layer(s) can be securely placed up against the edging as they are laid without moving the edging out of its correct position. Furthermore, removably fixing the edging to the mould means that the edging is not moved away from its correct position when a vacuum is applied, or during the resin infusion or curing process. When the forming process is complete, the edging can be unfixed from the mould as the component is de-moulded.

The method may comprise arranging a peel ply layer on the mould, and arranging the fibrous layers and the edging over the peel ply layer. In this way, in the finished component, a peel ply layer is provided on the undersurface of the component and extends over both the fibrous layers and the edging. The peel ply layer can subsequently be removed to provide a roughened surface on both the fibrous layers and the edging.

Additionally or alternatively, the method may comprise arranging a peel ply layer over the fibrous layers and the edging, so as to provide a peel ply layer on the upper surface of the component that extends over both the fibrous layers and the edging.

An initial thickness of the edging may be equal to or greater than an initial combined thickness of the fibrous layer(s), and the method may further comprise compressing the fibrous layer(s) and the edging during a vacuum-assisted moulding process such that the edging has a final thickness that is substantially the same as a final combined thickness of the fibrous layer(s). In this way, both the fibrous layers and the edging may be compressed to substantially the same thickness, so as to provide a continuous upper surface across the fibrous layers and to the edging.

The method may further comprise supplying liquid resin to the mould. Alternatively or additionally, the fibrous layers may be pre-impregnated with resin. The method may further comprise integrating the fibrous layers and the edging by curing the resin.

The invention extends to a composite component made according to the method of the invention described above, and to a shear web made according to the method of the invention described above. The invention also extends to a wind turbine blade comprising the shear web, and to a wind turbine comprising such a wind turbine blade.

The invention extends further to a composite component for a wind turbine blade comprising a laminate formed from one or more fibrous layers and a resin, the laminate having a laminate edge defined by an edge of the one or more fibrous layers and an edging located adjacent to the laminate edge and integrated with the laminate by the resin. The edging has a substantially resin-free exposed surface that defines a safety edge of the composite component.

The edging acts as a buffer that shields the edges of the fibrous layer(s) which would otherwise form sharp, serrated edges. In this way, the edge of the laminate component that is the substantially resin-free exposed surface of the edging, rather than serrated edges of the fibrous layers.

Because the exposed surface of the edging is substantially resin-free, the exposed surface is free from excess resin that would otherwise form uneven, sharp edges and pose a safety hazard to those handling the composite component. Thus, the substantial absence of hard resin from the edge of the component provides a hand-safe edge that makes the component relatively safe to handle.

Therefore, by means of the substantially resin-free exposed surface of the edging, the invention provides a hand-safe edge on a composite component for a wind turbine blade, without the need for lengthy and expensive processing after the component has been fabricated.

The edging may be made from substantially resin impermeable material. In this way, the inside core of the edging is kept substantially free from cured resin during fabrication of the component, making the edging relatively easy to cut to reveal the exposed surface. For example, the edging may comprise foam, balsa and/or polystyrene, and/or may be made from a closed-cell foam to avoid resin permeation.

The edging may be in the form of a strip. In this way, the edging can extend along a length of the edge of the component, and can bend to accommodate the shape of the edge. If necessary, multiple strips can be placed end-to-end to cover the full length of the edge.

The edging may be made from a compressible material. This is particularly beneficial when a vacuum stage is involved in the composite-forming process. When the fibrous layers of the composite component are placed under vacuum they are compressed. The compressibility of the edging means that the edging is also compressed when a vacuum is applied, so as to match the compression of the laminate layers, thereby providing a continuous surface across the laminate and the edging.

In embodiments where the edging is made from a compressible material, in the finished composite component the edging may be in a compressed state.

The composite component may comprise a peel ply layer arranged over the laminate and the edging. The peel ply layer may be removed to reveal a roughened surface on both the laminate and the edging, to facilitate bonding of both the laminate and the edging to another surface.

The safety edge of the composite component may be formed by severing the edging along a severance line and removing a sacrificial portion of the edging outboard of the severance line to reveal the substantially resin-free exposed surface of the edging. In this way, the substantially resin-free exposed surface can be formed quickly and easily, without the need for elaborate tools.

The component may be formed by means of VARTM.

The composite component may be a shear web. Alternatively, the composite component may be another component for a wind turbine, such as a bulkhead, a flange or a platform.

The invention also extends to a wind turbine blade comprising a composite component according to the invention described above, and to a wind turbine comprising such a wind turbine blade.

For the avoidance of doubt, the term ‘laminate’ as used herein is intended to encompass parts made up from one or more layers, and hence includes parts made from a single layer within its scope.

### BRIEF DESCRIPTION OF THE DRAWINGS

FIGS. 1 and 2 which illustrate a wind turbine blade in perspective and cross-sectional views respectively, and FIG. 3 which illustrates a method of making a shear web, have already been described above by way of background to the present invention. In order that the invention may be more readily understood, specific embodiments of the invention will now be described, by way of non-limiting example only, with reference to the following figures in which:

FIG. 4 is a schematic partial perspective view of a composite component according to an embodiment of the invention;

FIGS. 5A to 5I illustrate stages in a method of making the composite component of FIG. 4;

FIGS. 6A and 6B are a perspective view and partial enlarged cross-sectional view respectively of a composite component made by the method of FIGS. 5A to 5I; and

FIG. 7 is a cross-sectional view of a wind turbine blade incorporating the composite component of FIG. 6.

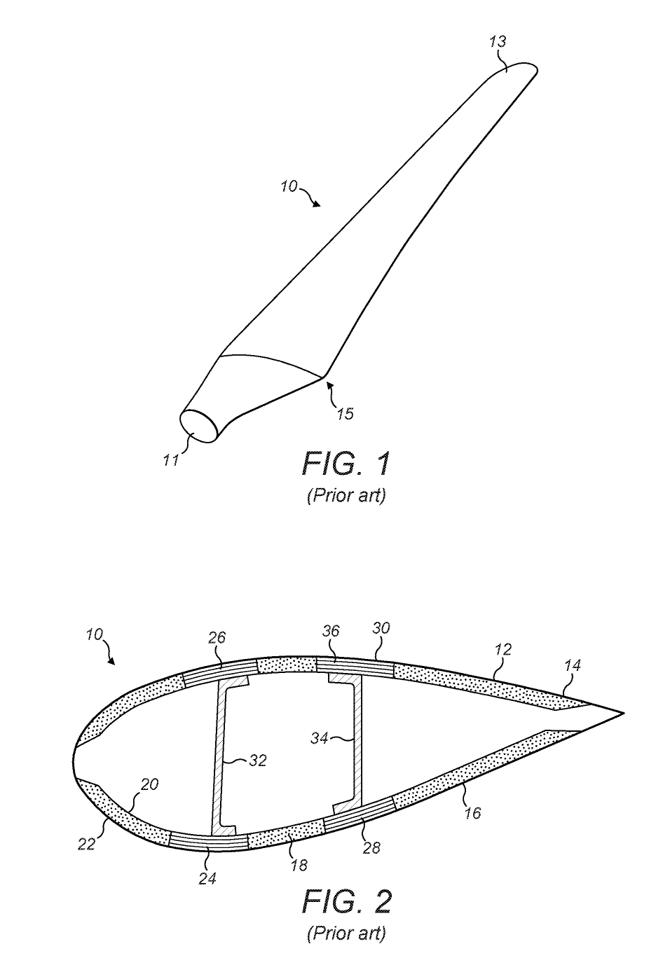

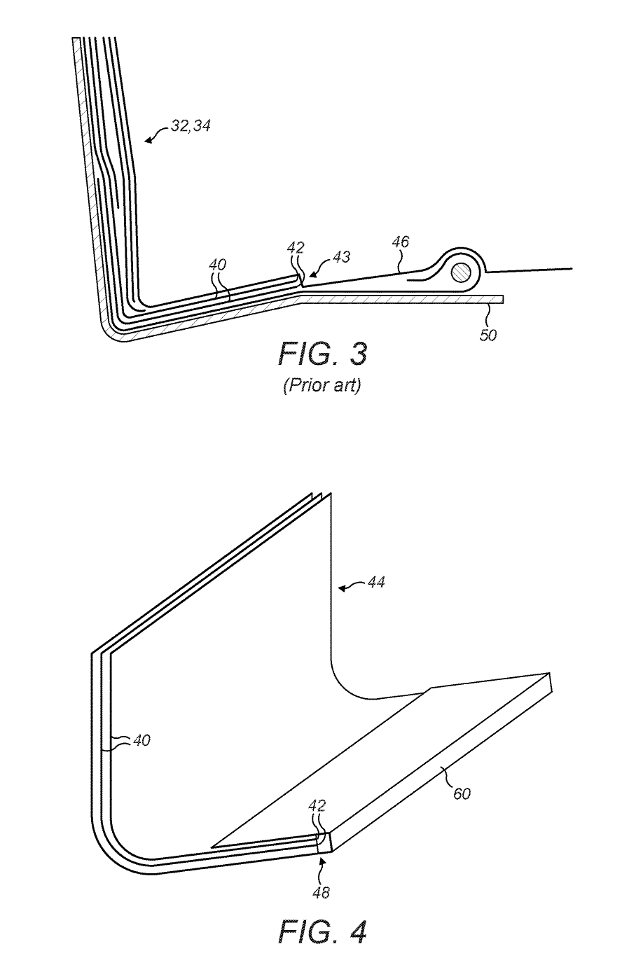

### DETAILED DESCRIPTION OF EMBODIMENTS OF THE INVENTION

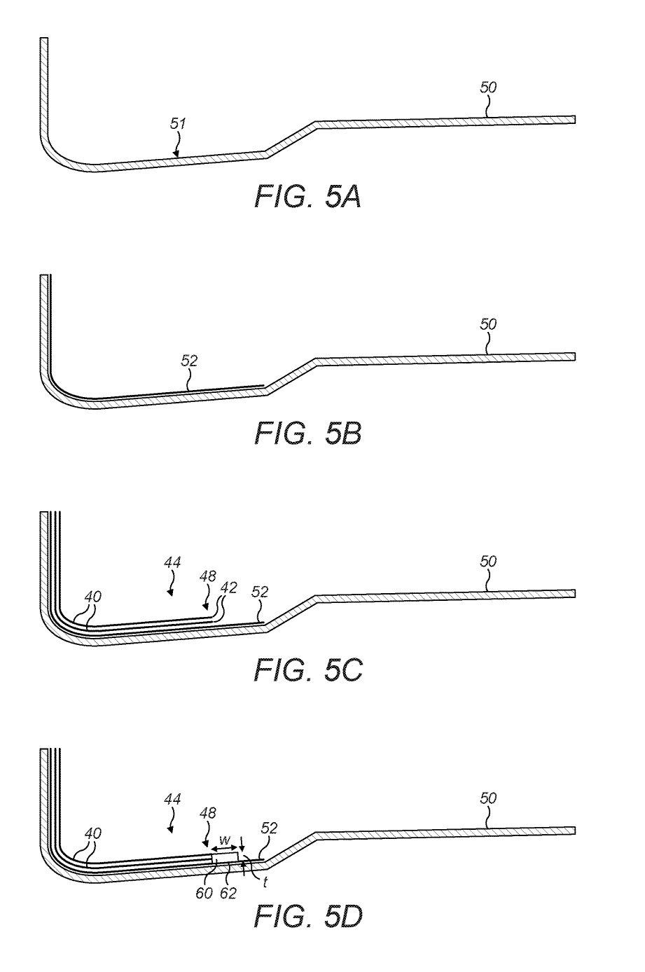

FIG. 4 illustrates a composite component 130 for a wind turbine blade. In this example, the composite component 130 is a shear web, and FIG. 4 illustrates the bottom part of the shear web only. The shear web 130 comprises a laminate 44 formed by a plurality of laminate layers 40, for example glass-fibre fabric layers, which are integrated together by cured resin. Edges 42 of the laminate layers 40 define a laminate edge 48. A strip of foam 60 extends alongside the laminate edge 48 and is integrated with the laminate 44 by the cured resin. As will be described in further detail later, the strip of foam 60 defines a hand safe edge of the shear web 130, allowing the shear web 130 to be safely handled in use.

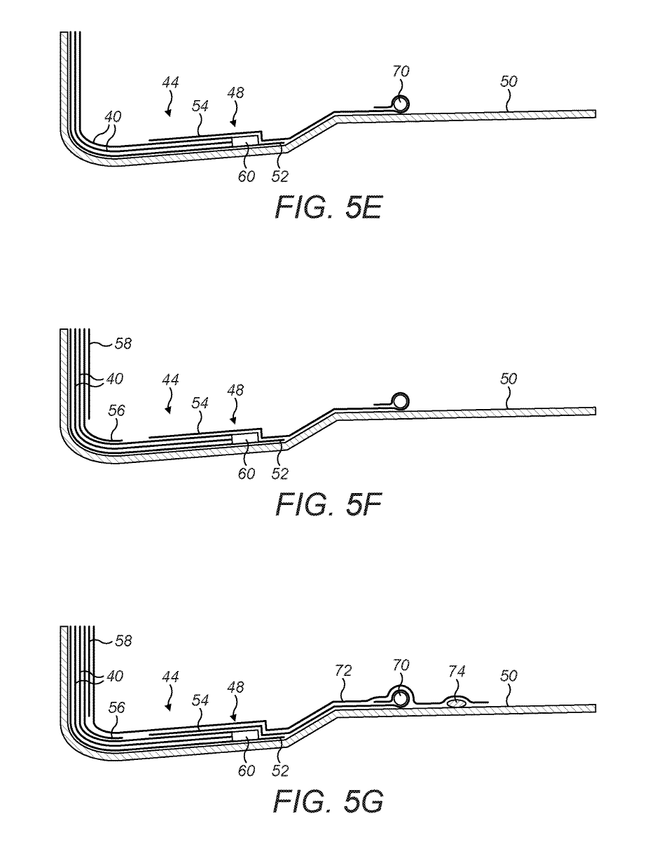

A method of making the shear web 130 will now be described with reference to FIGS. 5A to 5I.

Referring first to FIG. 5A, to make the shear web 130, a mould tool 50 is provided, which has a mould surface 51 corresponding in shape to the outer contour of the shear web 130 to be formed in the mould 50. A release film (not shown) is applied over the surface 51 of the mould tool 50. Next, and as shown in FIG. 5B, a first or lower peel ply layer 52 is arranged in the mould 50, over the release film.

As shown in FIG. 5C, the laminate layers 40, exemplified here as layers of glass fibre fabric, are laid over the peel ply layer 52. Whilst only glass fibre layers are illustrated in this example, it will be appreciated that the laminate 44 may include other layers or components, for example the shear web 130 may be of sandwich panel construction in which case core material such as foam or balsa may be provided between the fibrous layers 40. The edges 42 of the fibrous layers 40 are aligned in the mould tool 50, and are optionally trimmed once aligned. The edges 42 of the layers 40 define the laminate edge 48.

As shown in FIG. 5D, an edging 60 is arranged in the mould 50 alongside the laminate edge 48. The edging 60 is suitably formed from resin-impermeable and preferably compressible material. In this example, the edging 60 is a strip of closed-cell foam made of expanded neoprene or silicone. The closed cells of the foam substantially prevent resin from infusing into the bulk of the edging strip 60 during the subsequent resin infusion process.

The edging 60 has a width w of between approximately 5 mm and approximately 10 mm, and a thickness t of between approximately 3 mm and approximately 8 mm. The edging 60 is preferably at least as thick as the laminate 44 prior to consolidation of the laminate during the vacuum bagging process. Preferably, the edging 60 is slightly thicker than the laminate 44 prior to consolidation. As will be described later, the compressibility of the edging 40 enables it to be compressed during consolidation in step with the laminate 44 such that it ultimately has the same thickness as the consolidated laminate 44 in the finished component.

Referring still to FIG. 5D, an underside 62 of the edging strip 60 is pre-coated with an adhesive layer, and covered with a peelable protective layer (not illustrated). Before the strip 60 is placed on the mould tool 50, the protective layer is removed to expose the adhesive layer. The edging 60 is laid alongside the laminate edge 48 with the underside 62 facing downwardly towards the mould tool 50, such that the edging 60 is fixed to the mould tool 50 via the peel ply layer 52 to keep the edging 60 in place during subsequent processing steps.

Next, as shown in FIG. 5E, a second or upper peel ply layer 54 is laid over the laminate 44 and the edging 60. A vacuum channel 70 is then laid on top of the peel ply layer 54 outboard of the edging 60 and the peel ply layer 54 is folded around the vacuum channel 70. The vacuum channel 70 will later be used to evacuate air from the components in the mould tool 50.

Referring to FIG. 5F, once the vacuum channel is in place, a layer of release film 56 is laid over the laminate 44, and a layer of transfer mesh 58, which facilitates resin infusion, is laid over the release film 56.

Referring now to FIG. 5G, once all the components have been laid up in the mould tool 50, the components are covered by a vacuum bag 72. The vacuum bag 72 is sealed to the mould tool 50 using butyl rubber sealing tape 74 to create a sealed region around the components.

Air is then evacuated from the sealed region via the vacuum channel 70. As air is evacuated, the pressure differential between the inside and the outside of the vacuum bag 72 causes the vacuum bag to bear against and compress the fibrous layers 40. As mentioned previously, the edging 60 is also compressible under the vacuum pressure, and compresses along with the fibrous layers 40 as air is removed from the sealed region. During this consolidation process, the edging 60 is compressed such that it has a thickness corresponding to the thickness of the compressed laminate 44.

After the required vacuum level has been reached, resin is introduced into the sealed region. The resin infuses into and between the fibrous layers 40, and between the laminate edge 48 and the edging 60. Because the edging 60 is substantially resin impermeable, the resin does not appreciably infuse into the bulk or ‘core’ of the edging 60. Accordingly, the core of the edging 60 remains substantially resin free.

The resin is then cured by heating. As the resin cures, the edging 60 is integrated with the laminate 44, and is bonded to the laminate 44 along the laminate edge 48.

Once the resin has been cured the resulting shear web 130 is demoulded: the vacuum bag 72 is removed, the release film 56 and transfer mesh 58 are peeled away, the shear web 130 is removed from the mould tool 50 and the peel ply layers 52, 54 are trimmed (as shown in FIG. 5H).

Referring to FIG. 5I, this illustrates the finishing stage of the process. For illustrative purpose, in FIG. 5I the full outline of the edging 60 is shown, although it will be appreciated that in reality the upper surface of the edging 60 would be covered by the upper peel ply layer 54, and so would not be visible.

In the finishing stage, the edging 60 is severed along a severance line 62. The severance line 62 is spaced apart from the laminate edge 48 by a distance d, which is between approximately 2 mm and approximately 5 mm. In this way, a sacrificial portion 60a of the edging 60 outboard of the severance line 62 is removed from the component 130, and a shield portion 60b of the edging 60 inboard of the severance line 62 remains integrated with the laminate 44.

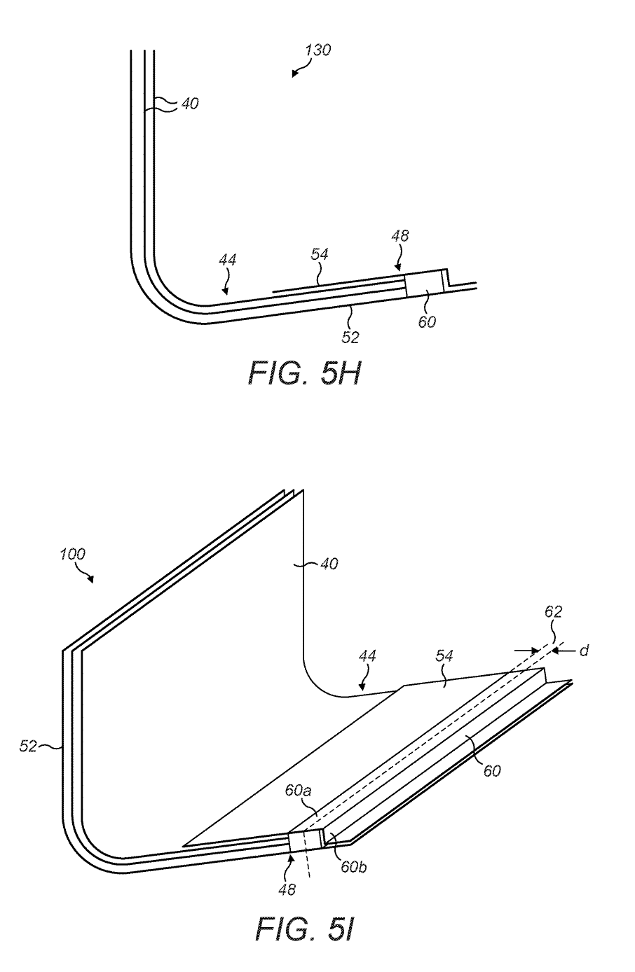

A thin layer of cured resin covers the outside of the edging 60 following the moulding process. However, the impermeable nature of the closed-cell foam means that resin is substantially absent from the bulk/core of the edging 60. Accordingly, when the edging 60 is severed along the severance line 62, a clean (i.e. resin-free) surface 64 (see FIG. 6A) of the shield portion 60b is exposed; this surface defines a hand-safe edge 64 of the shear web 130. The substantial absence of hard resin from this edge 64 makes it relatively safe to handle. The absence of resin from the core of the edging 60 also advantageously makes the edging 60 relatively easy to cut. For example it can be cut easily by hand using a knife, which is particularly convenient.

Once the severing process has been completed, there is no need to process the shear web 130 any further to allow for safe handling. This avoids the need for the time-consuming, labour-intensive machining processes that must be employed to finish the edges of composite components made by conventional methods.

FIGS. 6A and 6B illustrate the finished shear web 130. The shield portion 60b is integrated with the laminate 44 by the cured resin and shields the laminate edge 48 creating a hand-safe edge 64. As shown best in FIG. 6B, as a result of the consolidation process, the shield portion 60b is in a compressed state in which its thickness t is substantially equal to the thickness of the consolidated laminate 44.

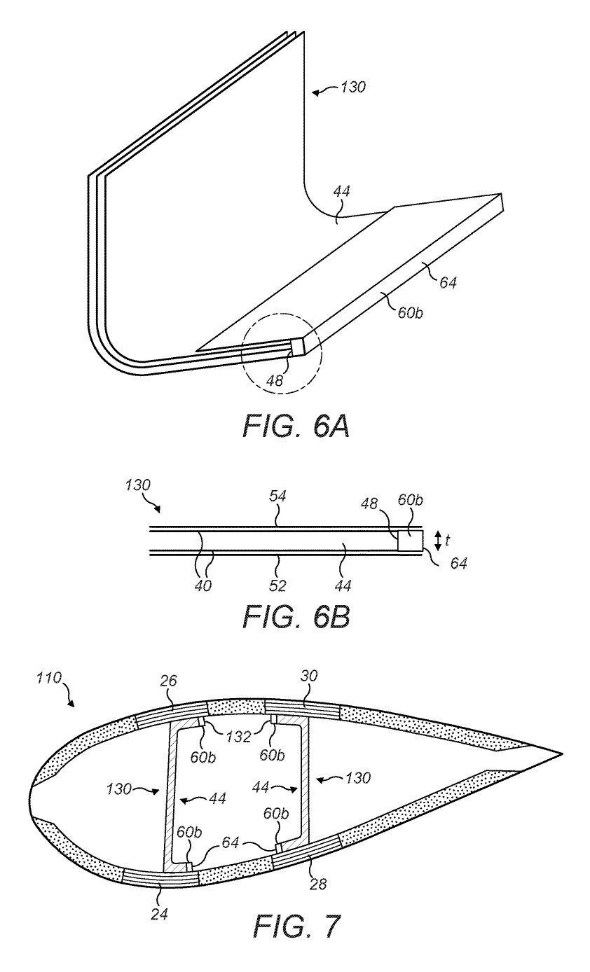

The peel ply layers 52, 54 extend over both the laminate 44 and the shield portion 60b of the shear web 130. When the shear web 130 is incorporated into a wind turbine blade 110, the peel ply layers 52, 54 are removed to leave a roughened keying surface on both the laminate 44 and the shield portion 60b. Adhesive is applied to this keying surface in order to bond the shear web 130 to the spar caps 24, 26, 28, 30 (see FIG. 7), with the roughness of the surface serving to improve the adhesion.

Aside from the handling advantages, the presence of the shield portion 60b does not significantly affect the physical properties of the shear web 130. As most clearly seen in FIG. 6B, the shield portion 60b is securely integrated with the laminate 44 by the cured resin, and the fact that the shield portion 60b is provided with peel ply layers 52, 54 in the same way as the laminate 44 means that the surface of the shield portion 60b can be securely adhered to the wind turbine blade 110.

As shown in FIG. 7, when the shear web 130 is incorporated into the wind turbine blade 110, the shear web 130 is disposed entirely in the interior of the blade 110. Thus, the edges 64 of the shear webs 130 are not visible. In the finished wind turbine blade 110, the appearance of the edges 64 is therefore unimportant.

Although in the embodiment described the composite component is a shear web, in other embodiments the composite component may be, for example, a bulkhead, flange or platform.

The edging need not be made of a foam material, but may be made of any suitable material, examples of which include fibrous material, honeycomb, rubber, balsa, and polystyrene. The edging need not be adhered to the mould tool by an adhesive layer, but may be fixed in place by any suitable means, or may simply lie on the mould tool without being fixed in place.

Any or all of the peel ply layers, the release film and/or the transfer mesh may be omitted if required. Additional components may also be laid up in the mould before the vacuum bag is arranged in place.

Although in the method described the fibrous layers are dry fibrous layers, and resin is infused into the layers in a resin-infusion process, the fibrous layers may be pre-preg layers that are impregnated with resin before being arranged in the mould tool. In this case, the resin-infusion step may be omitted.

In the example described, the edging is severed by hand using a knife. However, the edging may be severed by any suitable means, for example a saw or laser. In any case, the severing process may be either manual or automated. Although there is no need for subsequent machining after the severing process in order to provide a hand-safe edge, further machining and finishing stages may nonetheless be employed if desired.

In other embodiments, instead of being severed, the edging may be grinded or sanded to reveal a substantially resin-free exposed surface.

Whilst the edging is preferably made from substantially resin impermeable material, in other examples resin may be prevented from permeating into the bulk of the edging in other ways. For example, the edging may be encapsulated within a resin-impermeable film such as a plastics film. In such cases, the bulk of the edging need not necessarily be made from resin-impermeable material.

The present invention is therefore not limited to the exemplary embodiments described above and many other variations or modifications will be apparent to the skilled person without departing from the scope of the present invention as defined in the following claims.

1. A method of making a composite component for a wind turbine blade, the composite component having a safety edge, and the method comprising:
arranging one or more fibrous layers in a mould such that the layers define a laminate edge;
arranging an edging adjacent to the laminate edge;
integrating the fibrous layers and the edging by means of resin;
substantially preventing the resin from permeating into the edging; and
removing a portion of the edging to reveal a substantially resin-free exposed surface of the edging that defines a safety edge of the component.

2. The method of claim 2, wherein the step of removing a portion of the edging comprises:
severing the edging along a severance line spaced apart from the laminate edge; and
removing a sacrificial portion of the edging outboard of the severance line such that a shield portion of the edging inboard of the severance line remains integrated with the laminate and includes the substantially resin-free exposed surface defining the safety edge of the component.

3. The method of claim 1, wherein the edging is made from substantially resin impermeable material such that the resin is substantially prevented from permeating into the edging.

4. The method of claim 1, further comprising arranging a plurality of fibrous layers, one on top of the other, in the mould to form the laminate.

5. The method of claim 1, comprising removably fixing the edging to the mould.

6. The method of claim 1, comprising arranging a peel ply layer on the mould, and arranging the fibrous layers and the edging over the peel ply layer.

7. The method of claim 1, comprising arranging a peel ply layer over the fibrous layers and the edging.

8. The method of claim 1, wherein an initial thickness of the edging is equal to or greater than an initial combined thickness of the fibrous layer(s) and the method further comprises compressing the fibrous layer(s) and the edging during a vacuum-assisted moulding process such that the edging has a final thickness that is substantially the same as a final combined thickness of the fibrous layer(s).

9. The method of claim 1, further comprising supplying liquid resin to the mould.

10. The method of claim 1, further comprising integrating the fibrous layers and the edging by curing the resin.

11. A composite component made according to the method of claim 1.

12. A shear web made according to the method of claim 1.

13. A wind turbine blade comprising the shear web of claim 12.

14. A wind turbine comprising the wind turbine blade of claim 13.

15. A composite component for a wind turbine blade comprising:
a laminate formed from one or more fibrous layers and a resin, the laminate having a laminate edge defined by an edge of the one or more fibrous layers; and
an edging located adjacent to the laminate edge and integrated with the laminate by the resin;
wherein the edging has a substantially resin-free exposed surface that defines a safety edge of the composite component.

16. The composite component of claim 15, wherein the edging is made from a substantially resin impermeable material.

17. The composite component of claim 15, wherein the edging comprises foam, balsa and/or polystyrene.

18. The composite component of claim 17, wherein the edging is made from a closed-cell foam.

19. The composite component of claim 15, wherein the edging is in the form of a strip.

20. The composite component of claim 15, wherein the edging is made from a compressible material.

21. The composite component of claim 20, wherein the edging is in a compressed state.

22. The composite component of claim 15, further comprising a peel ply layer arranged over the laminate and the edging.

23. The composite component of claim 15, wherein the safety edge of the composite component is formed by severing the edging along a severance line and removing a sacrificial portion of the edging outboard of the severance line to reveal the substantially resin-free exposed surface of the edging.

24. The composite component of claim 15, wherein the component is formed by means of VARTM.

25. The composite component of claim 15, wherein the component is a shear web.

26. A wind turbine blade comprising the composite component of claim 15.

27. A wind turbine comprising the wind turbine blade of claim 26.
